(19) United States
(12) Patent Application Publication
(10) Pub. No.: US 2026/0006595 A1
(43) Pub. Date: Jan. 1, 2026

(54) DMRS SHARING AND PDSCH RATE MATCHING FOR FREQUENCY DIVISION MULTIPLEXED PDSCHS

(71) Applicant: QUALCOMM Incorporated, San Diego, CA (US)

(72) Inventors: Chih-Hao LIU, San Diego, CA (US); Jing SUN, San Diego, CA (US)

(21) Appl. No.: 18/757,459

(22) Filed: Jun. 27, 2024

(51) Int. Cl. H04W 72/0453; H04L 5/00; H04W 72/0457; H04W 72/1273

(52) U.S. Cl. CPC H04W 72/0453; H04L 5/0051; H04W 72/0457; H04W 72/1273

(57) ABSTRACT

Certain aspects of the present disclosure provide techniques for demodulation reference signal (DMRS) sharing and physical downlink shared channel (PDSCH) rate matching for frequency division multiplexed (FDMed) PDSCHs. A method performed by a user equipment (UE) may include receiving a first frequency domain resource allocation (FDRA) comprising an indication of a continuous set of frequency resources allocated for transmission of a plurality of FDMed PDSCH transmissions for a plurality of UEs, including the UE, receiving a second FDRA comprising an indication of a subset of frequency resources, of the continuous set of frequency resources, on which one or more PDSCH transmissions, of the plurality of FDMed PDSCH transmissions, for the UE are scheduled, and receiving, using the first FDRA and the second FDRA, the one or more PDSCH transmissions for the UE on the subset of frequency resources.

### BACKGROUND

### Field of the Disclosure

Aspects of the present disclosure relate to wireless communications, and more particularly, to techniques for demodulation reference signal (DMRS) sharing and physical downlink shared channel (PDSCH) rate matching for frequency division multiplexed PDSCHs.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of UEs, including the UE, receiving a second FDRA comprising an indication of a subset of frequency resources, of the continuous set of frequency resources, on which one or more PDSCH transmissions, of the plurality of FDMed PDSCH transmissions, for the UE are scheduled, and receiving, using the first FDRA and the second FDRA, the one or more PDSCH transmissions for the UE on the subset of frequency resources.

Another aspect provides a method for wireless communication by a network entity. The method includes transmitting a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of user equipments (UEs), including a UE, transmitting a second FDRA comprising an indication of a subset of frequency resources, of the continuous set of frequency resources, on which one or more PDSCH transmissions, of the plurality of FDMed PDSCH transmissions, for the UE are scheduled, and transmitting, using the first FDRA and the second FDRA, the one or more PDSCH transmissions for the UE on the subset of frequency resources.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a diagram illustrating an example associated with shared DMRS resources among multiple UEs.

FIG. 6 depicts a process flow including operations for communications in a network between a network entity and a user equipment.

FIG. 7 illustrates an example frequency resource allocation including a plurality of interlaces of frequency resources.

FIG. 8 illustrates an example of the resource block group (RBG)-based interleaving.

FIG. 9 depicts a method for wireless communications.

FIG. 10 depicts a method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for demodulation reference signal (DMRS) sharing and physical downlink shared channel (PDSCH) rate matching for frequency division multiplexed PDSCHs.

For example, in certain scenarios, for PDSCH transmissions involving multiple small packets sent by a network entity to a cluster of user equipment (UEs), the network entity may use frequency division multiplexing (FDM) to transmit multiple PDSCHs within the same slot across an allocated frequency band or bandwidth part (BWP). This approach aims to reduce transmission latency and enhance spectral efficiency. For such cases, UEs might be configured to use a wideband demodulation reference signal (DMRS) with tones spread across the FDMed PDSCHs, improving channel estimation and time/frequency loop tracking. However, despite the improved channel estimation, the FDMed PDSCHs may not benefit from frequency diversity of the entire allocated frequency band, as they are confined to smaller, continuous frequency portions rather than spanning the entire frequency band. Consequently, because the FDMed PDSCHs do not span the entire frequency band, they may be vulnerable to fading and interference, which may cause the FDMed PDSCHs to not be properly received by the UEs and may lead to poor spectral efficiency and poor user experience.

Accordingly, aspects of the present disclosure provide techniques for joint frequency domain PDSCH rate matching to improve channel frequency diversity when transmitting FDMed PDSCHs for a plurality of UEs. In some cases, these techniques may involve a network entity providing a first frequency domain resource allocation (FDRA) that indicates a continuous set of frequency resources allocated for transmission of a plurality of FDMed PDSCH transmissions for the plurality of UEs. Additionally, these techniques may further include the network entity providing a second FDRA that includes an indication of a subset of frequency resources, of the continuous set of frequency resources, on which one or more PDSCH transmissions, of the plurality of FDMed PDSCH transmissions, for a UE are scheduled. Accordingly, the first FDRA may indicate to the UE the continuous set of resources in which FDMed PDSCHs for the plurality of UEs are allocated and the second FDRA may indicate the subset of frequency resources on which PDSCH transmissions for that particular UE are scheduled.

In this manner, the network entity may be able to spread the FDMed PDSCH transmissions for the plurality of UEs across the entire continuous set of frequency resources to improve frequency diversity of the FDMed PDSCH transmissions while also being able to indicate to each particular UE the specific subset of frequency resources on which PDSCH transmissions for that particular UE are scheduled. Accordingly, by improving the frequency diversity, the FDMed PDSCH transmissions for the plurality of UEs may be less susceptible to fading and interference, which may improve overall communication reliability and performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

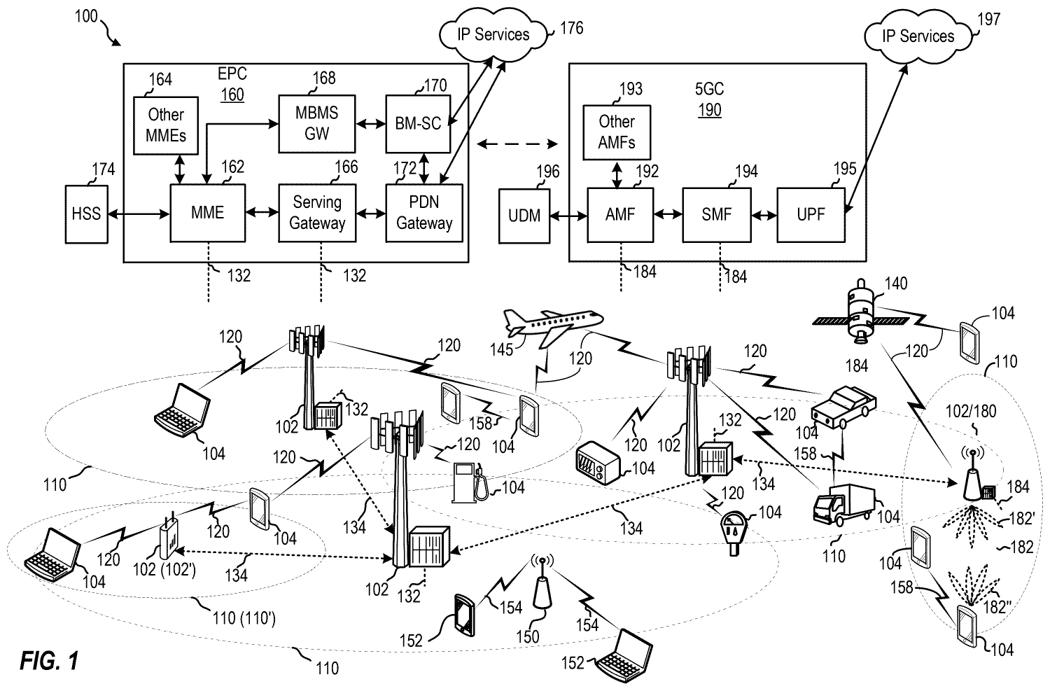

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

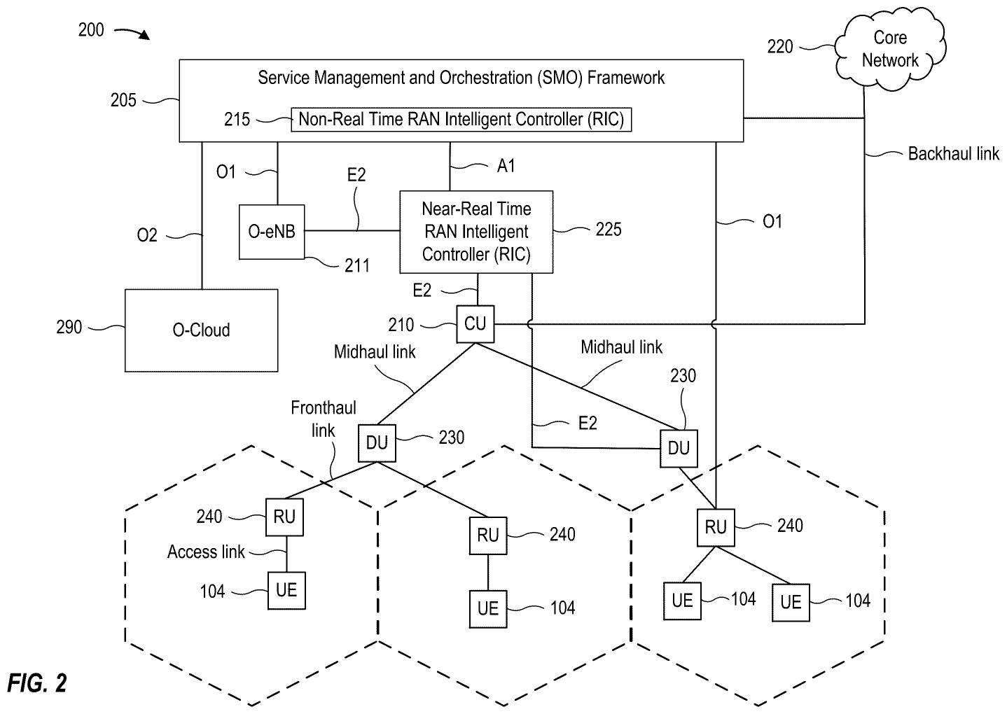

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

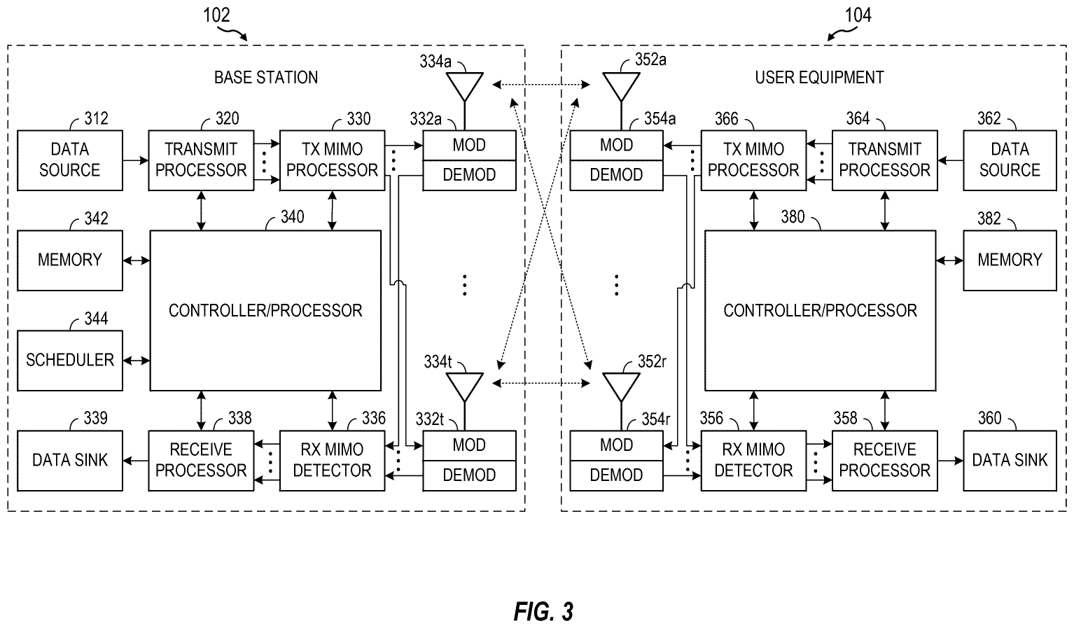

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

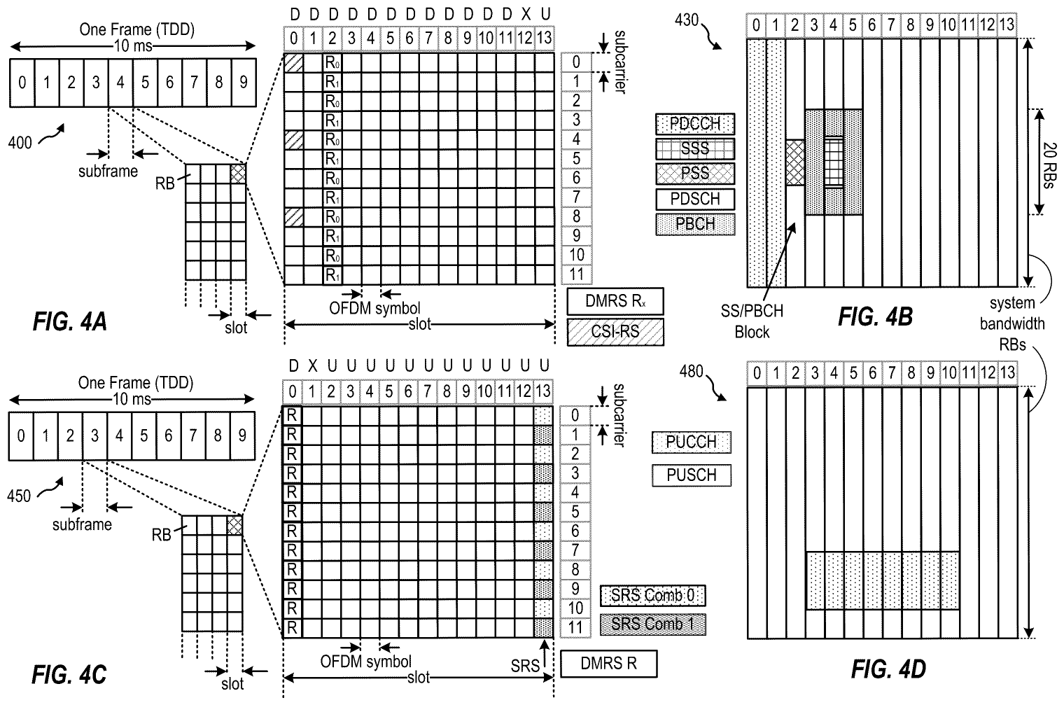

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to DMRS Sharing Among UEs

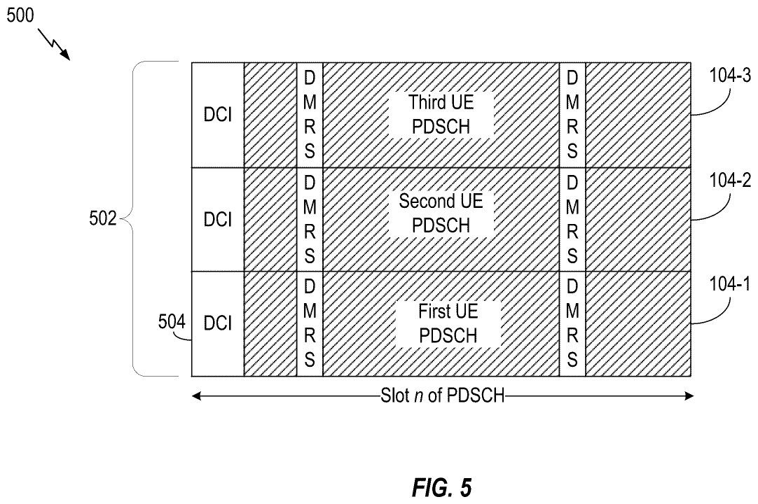

FIG. 5 is a diagram illustrating an example 500 associated with shared DMRS resources among multiple UEs, in accordance with the present disclosure. As shown in FIG. 5, example 500 includes a frequency division multiplexed (FDMed) physical downlink shared channel (PDSCH) for a first UE 104-1, a second UE 104-2, and a third UE 104-3 allocated in a frequency band 502 and a same transmission time interval (TTI) (e.g., slot n for PDSCH). The first UE 104-1, the second UE 104-2, and the third UE 104-3 may receive a resource grant from a network node (such as network node 110). The resource grant may grant resources for each of the first UE 104-1, the second UE 104-2, and/or the third UE 104-3 to receive DCI. In some aspects, the resource grant may grant resources for the first UE 104-1, the second UE 104-2, and/or the third UE 104-3 to receive one or more DMRSs.

In some aspects, the resource grant may include grant for one or more shared DMRSs. The term “shared DMRS” refers to an FDMed DMRS used by multiple UEs configured for FDM within a TTI. In some aspects, the resource grant may indicate whether the DMRS may be shared by multiple UEs. In some aspects, the resource grant may indicate the DMRS pattern. In some aspects, one or more of the first UE 104-1, the second UE 104-2, and/or the third UE 104-3 may share a precoder so the DMRS may be shared for channel estimation. In some aspects, the network node may indicate, to the first UE 104-1, the second UE 104-2, and/or the third UE 104-3, a subset of DMRS resources which use the same precoder.

To allow the first UE 104-1 to combine a shared DMRS from another PDSCH for wideband channel estimation or tracking loops, the network node may schedule one or more PDSCHs with the same precoder and indicate, to the first UE 104-1, the usable DMRS resources across one or more FDMed PDSCHs. In some aspects, the network node may indicate, to the first UE 104-1, the usable and combinable DMRS resources across multiple FDMed PDSCHs via a UE-specific or group common DCI 504. The UE specific DCI 504 may schedule the PDSCH for the first UE 104-1, and additional fields in the DCI 504 may indicate the combinable DMRS resources in the FDMed PDSCHs for improved channel estimation, tracking loop updates, and/or a combination thereof, among other examples. The group common DCI 504 may indicate, to a preconfigured group of UEs (such as the first UE 104-1, the second UE 104-2, and/or the third UE 104-3), that DMRS resources in one or more FDMed PDSCH can be shared for tracking loop updates.

In some aspects, to allow the first UE 104-1 to combine the shared DMRS from another PDSCH for wideband channel estimation or tracking loops, the network node may schedule two PDSCHs with the same precoder and indicate, to the first UE 104-1, the usable DMRS frequency resources across multiple PDSCH allocations. In some aspects, the DCI 504 may include one or more frequency domain resource assignments (FDRAs). For example, a first FDRA may indicate, to the first UE 104-1, one or more shared DMRS resources in the FDMed PDSCH of the second UE 104-2. A second FDRA may indicate, to the first UE 104-1, one or more shared DMRS resources in the FDMed PDSCH of the third UE 104-3. In some aspects, the FDMed PDSCH of the second UE 104-2 is contiguous with the PDSCH of the first UE 104-1. In some aspects, the FDMed PDSCH of the second UE 104-2 is not contiguous with the PDSCH of the first UE 104-1. In some aspects, the FDMed PDSCH of the third UE 104-3 is contiguous with the PDSCH of the first UE 104-1. In some aspects, the FDMed PDSCH of the third UE 104-3 is not contiguous with the PDSCH of the first UE 104-1. In some aspects, resources for the shared DMRS may be granted in instances of contiguous PDSCH allocations. For contiguous shared DMRS allocations across multiple FDMed PDSCHs, an additional FDRA (e.g., the first FDRA, the second FDRA, or a third FDRA) may indicate an entire frequency span of sharable DMRS tones. In some aspects, the frequency span may include an original PDSCH frequency allocation, if any. In some aspects, the frequency span may be derived from a PDSCH FDRA. In some aspects, if other sharable DMRS tones from other FDMed PDSCHs are allowed to be non-contiguous, one FDRA may be used per contiguous segment of sharable DMRS tones. Multiple FDRAs may be used if the sharable DMRS tones are from multiple non-contiguous FDMed PDSCHs.

To improve the edge tone channel estimation for a physical resource block group (PRG)-based minimum mean square error (MMSE) channel estimation, the first UE 104-1 may include DMRS tones of one or more adjacent UEs (e.g., the second UE 104-2 and/or the third UE 104-3) to treat edge orphan resource blocks (RBs) as a whole PRG. For PRG-based frequency channel estimation, the DCI 504 may indicate if the DMRS tones on the upper and/or lower edge of the PDSCH allocation can be combined (e.g., shared) with the edge DMRS tones of the FDMed PDSCHs. In some aspects, two bits in the DCI 504 may be used to provide the indication. For example, a first bit may indicate whether the DMRS tones on the upper edge RBs can be combined, and a second bit may indicate whether the DMRS tones on the lower edge RBs can be combined. In some aspects, the first UE 104-1 may be configured to use the first bit, the second bit, or both, in the DCI 504 to determine if the DMRS RBs can be shared between adjacent PDSCHs to make an edge orphan RB into whole PRG so a full MMSE channel estimation matrix may be applied. In some aspects, to improve the edge tone channel estimation with MMSE interpolation instead of extrapolation, the first bit, the second bit, or both, in the DCI 504 may indicate whether the first UE 104-1 can interpolate the PDSCH edge tone from a preconfigured number of DMRS tones from one or more adjacent PDSCHs.

In some aspects, the network node may be configured to select different DMRS ports for shared DMRS tones across FDMed PDSCHs. The UEs (such as the first UE 104-1, the second UE 104-2, and/or the third UE 104-3), may be configured to combine the shared DMRS by using the same precoder as, for example, the PDSCH of the first UE 104-1. In some aspects, the network node may output the DCI 504 to indicate the DMRS ports for shared DMRS resources in another FDMed PDSCH. In some aspects, the number of DMRS ports in another FDMed PDSCH may be the same as the number of DMRS ports in the PDSCH of the first UE 104-1. In some aspects, the DCI 504 may indicate the DMRS port index (or indices) associated with the shared DMRS tones for each sharable PDSCH. The port of the shared DMRS tones may be in a different orthogonal codebook configuration (OCC) in a same code division multiplexing (CDM) group. For example, in MU-MIMO communication, the network node may be configured to select port 1 to transmit the PDSCH to the third UE 104-3 using the same precoder as the PDSCH transmitted in port 0 to the first UE 104-1. Port 0 of the frequency resources for the third UE 104-3, therefore, may be assigned to another UE with a different precoder.

In some aspects, an initial seed of a DMRS sequence may depend on two scrambling identifiers (e.g., scramblingID0 and scrambling ID1). For DCI format 1_1, a DMRS sequence initialization value may be associated with one of the scrambling identifiers. In some aspects, for the first UE 104-1 to descramble the DMRS tones for a sharable PDSCH, the first UE 104-1 may receive the scrambling identifier. In some aspects, the sharable PDSCH (e.g., the PDSCH of the second UE 104-2 or the PDSCH of the third UE 104-3) may be RRC-configured with the same scrambling identifier as the PDSCH of the first UE 104-1. If the sharable PDSCH dynamically changes the scrambling identifier based on a DCI indication, the DCI 504 for the first UE 104-1 may indicate, for each sharable PDSCH, that the scrambling identifier was dynamically changed.

In some aspects, to have the shared DMRS in the same DMRS symbols and comb pattern as in the PDSCH of the first UE 104-1, the DMRS configuration type, PDSCH mapping time, the number of DMRS symbols, and a DMRS additional position may be aligned. For example, relative to the PDSCH of the first UE 104-1, the sharable PDSCH may be configured with the same DMRS configuration type, the same PDSCH mapping type, the same single or double symbol DMRS, the same DMRS locations, and/or a combination thereof, among other examples. The network node may be configured to confirm that the PDSCHs (e.g., the sharable PDSCH and the PDSCH of the first UE 104-1) have the same configuration before indicating the first UE 104-1 to combine the DMRS tones from one or more other PDSCHs. For the same DMRS locations, the sharable PDSCH may have more DMRS symbols than the PDSCH of the first UE 104-1. In some aspects, the DMRS symbols of the PDSCH of the first UE 104-1 may be a subset of the DMRS symbols of the sharable PDSCH.

In some aspects, due to power control for different UEs, the Rx power from sharable DMRS tones in different FDMed PDSCHs may be different. To allow the DMRS to be combinable for channel estimation, the power of the DMRS may be normalized. In some aspects, the DCI 504 may indicate a power scaling offset factor for each FDMed PDSCH with respect to a reference PDSCH. The DCI 504 may indicate the transmit (Tx) power offset for each FDMed PDSCH with respect to the reference PDSCH due to PDSCH power control. If the DCI 504 is used to schedule a PDSCH, the DCI 504 may be used to schedule the reference PDSCH. If the DCI 504 is not used to schedule a PDSCH (e.g., group common DCI), the reference PDSCH may be specified in the DCI 504. In some aspects, the reference PDSCH may be the FDMed PDSCH in a lowest frequency or the FDMed PDSCH in a highest frequency. In some aspects, the reference PDSCH may be explicitly indicated via an FDMed PDSCH index where the indexing may order the FDMed PDSCHs by frequency (e.g., lowest frequency to highest frequency or highest frequency to lowest frequency). In some aspects, such as when there is not an independent FDRA indication for each FDMed PDSCH, a single DMRS FDRA may be signaled in the DCI 504. In some aspects, the DCI 504 may further indicate a relative starting RB, the number of RBs for each FDMed PDSCH, and/or a combination thereof, among other examples. In some aspects, the UE (e.g., the first UE 104-1, the second UE 104-2, and/or the third UE 104-3) may be configured to determine the power scaling offset relative to a segment of the DMRS tones.

### Aspects Related to DMRS Sharing and PDSCH Rate Matching for FDMed PDSCHs

In some cases, for PDSCH transmissions with multiple small packets that are transmitted by the network entity towards a same cluster of UEs, the network entity may want to FDM multiple PDSCHs in a same slot to reduce transmission latency and improve spectral efficiency. Accordingly, as discussed above with respect to FIG. 5, PDSCH transmissions for a plurality of UEs may be transmitted by the network entity using FDM. In such scenarios, these UEs may be configured to use a wideband demodulation reference signal (DMRS) including tones allocated across the FDMed PDSCHs to improve the channel estimation and time/frequency loop tracking. However, even though the channel estimation quality may be improved by using the wideband DMRS, the FDMed PDSCH may not benefit from frequency diversity of the entire allocated bandwidth. For example, as shown in FIG. 5, the PDSCH for each of the first UE 104-1, the second UE 104-2, and the third UE 104-3 is allocated to only a smaller, continuous portion of the frequency band 502 rather than being spread across the entire frequency band 502. As a result, due to the lack of frequency diversity, the PDSCH for each of the first UE 104-1, the second UE 104-2, and the third UE 104-3 may be more susceptible to fading and interference, which may degrade overall communication reliability and performance.

Accordingly, aspects of the present disclosure provide techniques for joint frequency domain PDSCH rate matching to improve channel frequency diversity when transmitting FDMed PDSCHs for a plurality of UEs. In some cases, these techniques may involve a network entity providing a first frequency domain resource allocation (FDRA) that indicates a continuous set of frequency resources allocated for transmission of a plurality of FDMed PDSCH transmissions for the plurality of UEs. Additionally, these techniques may further include the network entity providing a second FDRA that includes an indication of a subset of frequency resources, of the continuous set of frequency resources, on which one or more PDSCH transmissions, of the plurality of FDMed PDSCH transmissions, for a UE are scheduled. Accordingly, the first FDRA may indicate to the UE the continuous set of resources in which FDMed PDSCHs for the plurality of UEs are allocated and the second FDRA may indicate the subset of frequency resources on which PDSCH transmissions for that particular UE are scheduled.

In this manner, the network entity is able to spread the FDMed PDSCH transmissions for the plurality of UEs across the entire continuous set of frequency resources to improve frequency diversity of the FDMed PDSCH transmissions while also being able to indicate to each particular UE the specific subset of frequency resources on which PDSCH transmissions for that particular UE are scheduled. Accordingly, by improving the frequency diversity, the FDMed PDSCH transmissions for the plurality of UEs may be less susceptible to fading and interference, which may improve overall communication reliability and performance.

### Example Operations of Entities in a Communications Network

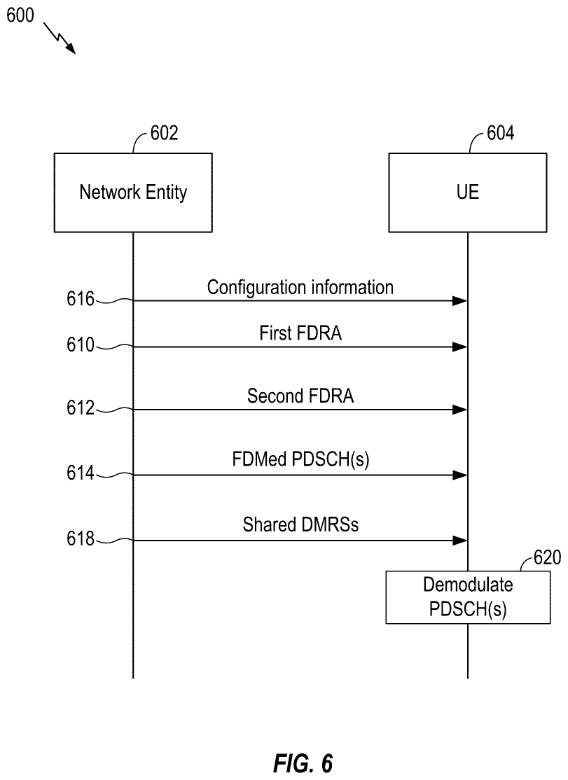

FIG. 6 depicts a process flow including operations 600 for communications in a network between a network entity 602 and a user equipment (UE) 604. In some aspects, the network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, UE 604 may be another type of wireless communications device and network entity 602 may be another type of network entity or network node, such as those described herein.

As shown, operations 600 begin at 610 with the UE 604 receiving, from the network entity 602, a first FDRA comprising an indication of a continuous set of frequency resources allocated for transmission of a plurality of FDMed PDSCH transmissions for a plurality of UEs, including the UE 604. In some cases, the plurality of FDMed PDSCH transmissions for the plurality of UEs may share a same wide-band precoder in the continuous set of frequency resources. In some cases, the first FDRA may be included within a first downlink control information (DCI) message transmitted by the network entity 602. In some cases, the continuous set of frequency resources may comprise a bandwidth part (BWP).

As shown at 612, the UE 604 receives, from the network entity 602, a second FDRA comprising an indication of a subset of frequency resources, of the continuous set of frequency resources, on which one or more PDSCH transmissions, of the plurality of FDMed PDSCH transmissions, for the UE 604 are scheduled. In some cases, the subset of frequency resources may comprise a subset of resource elements (REs) or a subset of resource blocks (RBs) of the continuous set of frequency resources. In some cases, the second FDRA may also be included in the first DCI message transmitted by the network entity 602 or may be included in a second DCI message transmitted by the network entity 602.

At 616, the UE 604 receives, using the first FDRA and the second FDRA, the one or more PDSCH transmissions for the UE on the subset of frequency resources. In some cases, the one or more PDSCH transmissions for the UE 604 may be rate matched to the subset of frequency resources while a remaining subset of frequency resources of the continuous set of frequency resources may be rate matched to other UEs in the plurality of UEs.

In some cases, the subset of frequency resources on which one or more PDSCH transmissions for the UE 604 are scheduled may be indicated in different manners. For example, in some cases, the subset of frequency resources may be indicated as one or more interlaces of frequency resources of a plurality of interlaces included within the continuous set of frequency resources.

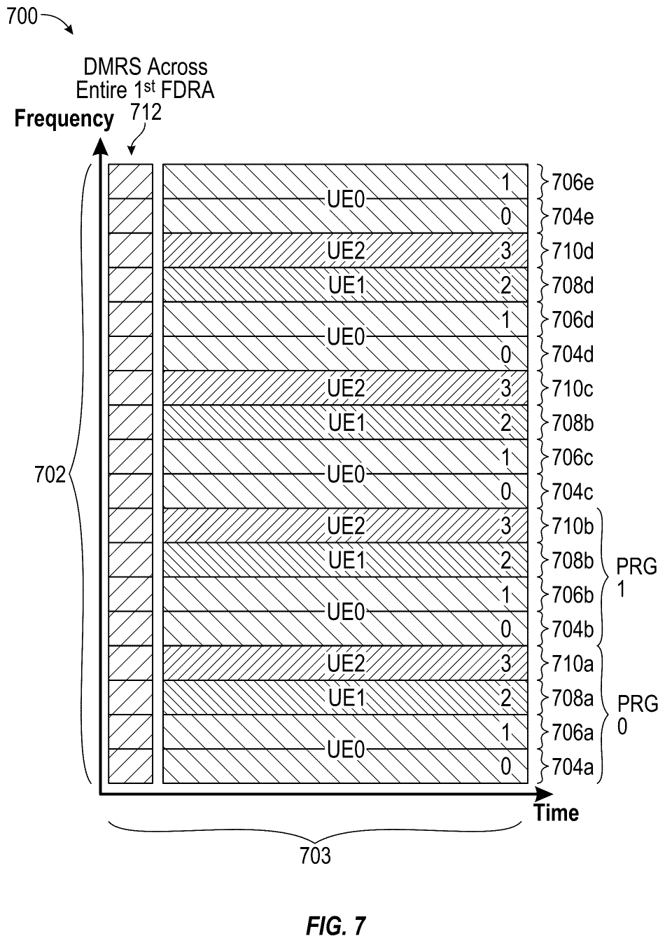

FIG. 7 illustrates an example frequency resource allocation 700 including a plurality of interlaces of frequency resources. For example, as shown, the frequency resource allocation 700 includes a continuous set of frequency resources 702 allocated for transmission of a plurality of FDMed PDSCH transmissions for a plurality of UEs, such as UE0, UE1, and UE2, in a slot 703 (e.g., a TTI). In some cases, any of UE0, UE1, or UE2 may be representative of UE 604 described with respect to FIG. 6. As discusses above, the continuous set of frequency resources 702 may be indicated in the first FDRA. Additionally, as shown, the continuous set of frequency resources 702 includes a plurality of interlaces of frequency resources, including a first interlace of frequency resources 704 associated with UE0, a second interlace of frequency resources 706 associated with UE0, a third interlace of frequency resources 708 associated with UE1, and a fourth interlace of frequency resources 710 associated with UE2.

Further, as shown, each interlace of frequency resources of the plurality of interlaces of frequency resources includes a plurality of interlace clusters. For example, the first interlace of frequency resources 704 includes interlace clusters 704a, 704b, 704c, 704d, and 704e. Similarly, the second interlace of frequency resources 706 includes interlace clusters 706a, 706b, 706c, 706d, and 706e. Additionally, the third interlace of frequency resources 708 includes interlace clusters 708a, 708b, 708c, and 708d. Additionally, the fourth interlace of frequency resources 710 includes interlace clusters 710a, 710b, 710c, and 710d.

As shown, each interlace of frequency resources may have a particular structure. In some cases, the structure of an interlace of frequency resources may be defined by a first number of REs/RBs per interlace cluster of the interlace of frequency resources and a second number of REs/RBs between interlace clusters of the interlace of frequency resources. For example, as shown, each interlace cluster of the plurality of interlace clusters of an interlace of frequency resources occupies a first number of frequency resources (e.g., REs or RBs) of the continuous set of frequency resources. Additionally, as shown, each interlace cluster of the plurality of interlace clusters is separated from another interlace cluster of the plurality of interlace clusters by a second number of frequency resources (e.g., REs or RBs) of the continuous set of frequency resources. For example, as can be seen in FIG. 7, the interlace cluster 704a occupies one RB and is separated from interlace cluster 704b by three RBs.

Further, as shown in FIG. 7, each interlace cluster of the plurality of interlace clusters of an interlace of frequency resources may be indexed periodically within a precoding resource group (PRG) using an interlace index. For example, as shown, a first 4-RB PRG (e.g., PRG 0) may include the interlace cluster 704a having an index 0, the interlace cluster 706a having an index 1, the interlace cluster 708a having an index 2, and the interlace cluster 710a having an index 3. Thereafter, as shown, the indices repeat for a second 4-RB PRG (e.g., PRG 1). For example, as shown, PRG 1 includes the interlace cluster 704b having an index 0, the interlace cluster 706b having an index 1, the interlace cluster 708b having an index 2, and the interlace cluster 710b having an index 3, and so on.

Returning to FIG. 6, in some cases, the indication of the subset of frequency resources in the second FDRA received by the UE 604 at 612 may comprise an indication of at least a first interlace of frequency resources assigned to the UE 604 on which the one or more PDSCH transmissions for the UE are scheduled. In some cases, the subset of frequency resources on which the one or more PDSCH transmissions for the UE are scheduled comprise the plurality of interlace clusters of at least the first interlace of frequency resources. For example, assuming that UE 604 is UE0 in FIG. 7, the second FDRA may include an indication of the first interlace of frequency resources 704 and the second interlace of frequency resources 706 on which an FDMed PDSCH(s) is scheduled for the UE 604. Additionally, in this scenario, the subset of frequency resources may include 704a-e and 706a-e.

As noted above, each interlace of frequency resources may have a particular structure. Accordingly, in some cases, the network entity 602 may transmit configuration information, to the UE 604 at 616 in FIG. 6, including an indication of the structure of at least the first interlace of frequency resources assigned to the UE 604. For example, the network entity 602 may be configured to transmit configuration information to the UE 604 that indicates (1) the first number of frequency resources occupied by each interlace cluster of the plurality of interlace clusters of at least the first interlace of frequency resources and (2) the second number of frequency resources separating each interlace cluster of the plurality of interlace clusters of at least the first interlace of frequency resources. In some cases, the configuration information comprises one of a radio resource control (RRC) message, a layer 2 (L2) message, or a DCI message.

In some cases, the indication of at least the first interlace of frequency resources comprises a bitmap. In some cases, the bitmap comprises a plurality of bits and each different bit of the plurality of bits corresponds to a different interlace of frequency resources of the plurality of interlaces of frequency resources. In some cases, a first bit value of the different bit indicates that the different interlace corresponding to that different bit is assigned to the UE. In some cases, a second bit value of the different bit indicates that the different interlace corresponding to that different bit is not assigned to the UE. In some cases the first bit value may equal 1 and the second bit value may equal 0 or vice versa.

For example, assuming a four-bit bitmap, a first bit of the bitmap may correspond to the first interlace of frequency resources 704 of FIG. 7, a second bit of the bitmap may correspond to the second interlace of frequency resources 706, a third bit of the bitmap may correspond to the second interlace of frequency resources 708, and a fourth bit of the bitmap may correspond to the second interlace of frequency resources 710. Accordingly, assuming that UE 604 is UE0 in FIG. 7, the bitmap may equal 1100, indicating that the first interlace of frequency resources 704 and the second interlace of frequency resources 706 are both assigned to the UE 604 while the third interlace of frequency resources 708 and the fourth interlace of frequency resources 710 are not assigned to the UE 604.

In some cases, the indication of the subset of frequency resources in the second FDRA comprises a resource indication value (RIV). For example, in some cases, the RIV may indicate a starting interlace and a number of contiguous interlaces that are assigned to the UE starting from the starting interlace. For example, the RIV may indicate the first interlace of frequency resources 704 as the starting interlace and may indicate that there is two contiguous interlaces (e.g., the first interlace of frequency resources 704 and the second interlace of frequency resources 706). Accordingly, based on the RIV, the UE 604 may determine that the first interlace of frequency resources 704 and the second interlace of frequency resources 706 are both assigned to the UE 604.

In some cases, the number of interlaces of frequency resources of the plurality of interlaces of frequency resources may be configurable. For example, FIG. 7 illustrates four interlaces for the continuous set of frequency resources 702. However, it should be appreciated that the number of interlaces of frequency resources for the continuous set of frequency resources 702 could be another number, such as 2 or 3. In such cases, a length of the bitmap (e.g., number of bits in the bitmap) and a length of the RIV may be a function of the number of interlaces of frequency resources of the plurality of interlaces of frequency resources of the continuous set of frequency resources 702.

In some cases, in addition to the FDMed PDSCHs allocated for transmission within the continuous set of frequency resources indicated within the first FDRA, the continuous set of frequency resources may also include a set of FDMed DMRSs that may be shared among UEs and used for channel estimation and to improve demodulation of the FDMed PDSCHs. For example, as shown at 618 in FIG. 6, the UE 604 may receive one or more DMRSs of the set of shared DMRSs. At 620, the UE 604 may then demodulate the one or more PDSCH transmissions received at 614 based on the received one or more DMRSs.

For example, as shown in FIG. 7, the frequency resource allocation 700 includes a set of shared DMRSs 712 that are scheduled for transmission across the continuous set of frequency resources. In the example shown in FIG. 7, DMRS of the set of shared DMRSs 712 are shown as being contiguous in a frequency domain and being scheduled at the beginning of slot 703 prior to the FDMed PDCHs for UEs 0-2. However, it should be appreciated that the individual DMRS of the set of shared DMRSs may be distributed in time and frequency across the continuous set of frequency resources 702 and the slot 703. For example, some shared DMRSs of the set of shared DMRSs may be transmitted at the end of the slot 703, in the middle of slot 703, or, for example, any REs in the continuous set of frequency resources 702 and slot 703 that are not scheduled for PDSCH transmissions. In other words, the set of shared DMRSs 712 may be scheduled in frequency resources (e.g., REs), of the continuous set of frequency resources 702, that are not scheduled for PDSCH transmissions of the plurality of FDMed PDSCH transmissions.

As noted above, the subset of frequency resources on which one or more PDSCH transmissions for the UE 604 are scheduled may be indicated in different manners. For example, in some cases, rather than indicating the subset of frequency resources as an interlace of frequency resources, the subset of frequency resources may be indicated based on frequency domain resource block group (RBG)-based interleaving. Accordingly, for example, in some cases, an RBG-based VRB-to-PRB interleaver may be defined and may be used to map virtual resource blocks (VRBs) to physical resource blocks (PRBs) that are scheduled with PDSCH transmissions for the UE 604 within the continuous set of frequency resources. In some cases, contiguous PRBs in the continuous set of frequency resources indicated in the first FDRA may be are grouped into an RBG with predetermined RBG size. In some cases, the RBG size may be 1, 2, or 4 RBs. In some cases, the RBG-based VRB-to-PRB interleaver may be configured based on the entire continuous set of frequency resources with a preconfigured interleaver depth, which may specify the number of rows of the RBG-based VRB-to-PRB interleaver. In some cases, RBGs may be sequentially input into the predefined interleaver with column first and row second manner and read out from interleaver with row first and column second manner.

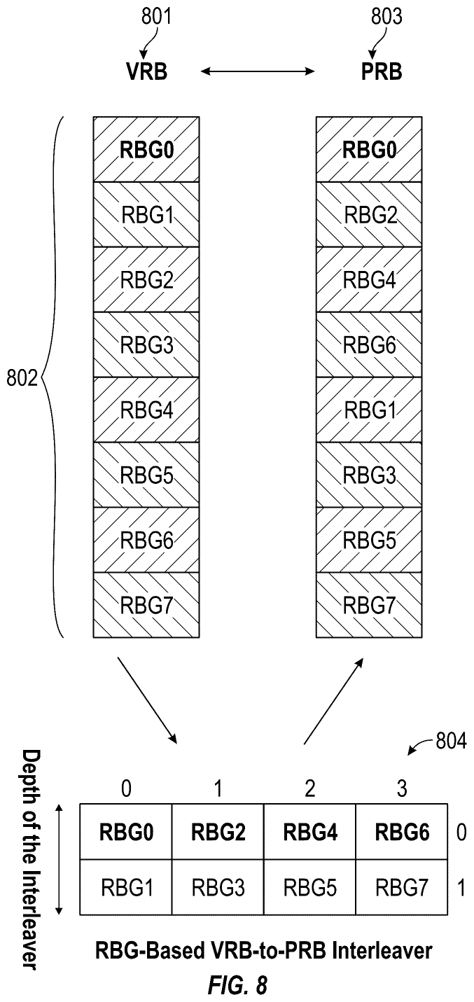

FIG. 8 illustrates an example 800 of the RBG-based interleaving discussed above. As shown, the example 800 includes a continuous set of frequency resources 802 that include a plurality of virtual resource blocks (VRBs) 801 that may map to a plurality of PRBs 803. The plurality of VRBs 801 may be arranged or included in a plurality of RBGs, such as RBG0 through RBG7, defined within the continuous set of frequency resources 802. As shown at 804, the plurality of RBGs may then be input into the RBG-based VRB-to-PRB interleaver having a defined interleaver depth (e.g., 2 rows in FIG. 8).

As noted above, in some cases, the continuous set of frequency resources 802 are included within a BWP. In some cases, the RBG-based VRB-to-PRB interleaver shown at 804 may be defined with respect to the continuous set of frequency resources 802 rather than the BWP, which may be indicated in the first FDRA described above. In some cases, the RBG-based VRB-to-PRB interleaver shown at 804 may be defined with respect to the BWP.

As shown, the plurality of RBGs may be input into the RBG-based VRB-to-PRB interleaver in a column first and row second manner and read out from interleaver with row first and column second manner. For example, RBG0 may be input first into the RBG-based VRB-to-PRB interleaver in column 0 and row 0. Thereafter, RBG1 may be input into column 0 and row 1. Thereafter, RBG2 may be input into column 1 and row 0, and so on. Thereafter, the RBGs may be read out of the RBG-based VRB-to-PRB interleaver in a row first and column second manner to obtain a VRB-to-PRB mapping (e.g., mapping the plurality of VRBs 801 to the plurality of PRBs 803), which may be used to indicate the subset of frequency resources on which the one or more PDSCHs for the UE 604 are scheduled.

For example, returning to FIG. 6, in some cases, the indication of a subset of frequency resources in the second FDRA received by the UE 604 at 614 in FIG. 6 may comprise an indication of a set of VRBs included within one or more RBGs (e.g., RBG0 through RBG7 of FIG. 8) defined within the continuous set of frequency resources (e.g., the continuous set of frequency resources 802 of FIG. 8). In some cases, the set of VRBs are defined with respect to the continuous set of frequency resources (e.g., a BWP). As described above, the set of VRBs may map to a corresponding set of PRBs in the continuous set of frequency resources indicated in the first FDRA based on the RBG-based VRB-to-PRB interleaver (e.g., the RBG-based VRB-to-PRB interleaver shown at 804 in FIG. 8). In some cases, the subset of frequency resources comprise the set of PRBs.

In some cases, the UE 604 may receive an indication of an interleaver depth of the RBG-based VRB-to-PRB interleaver from the network entity 602, such as in the configuration information transmitted at 616 in FIG. 6. In some cases, the indication of the interleaver depth is received in RRC signaling from a network entity 602. In some cases, the UE may determine the set of PRBs to which the set of VRBs correspond based on the interleaver depth of the RBG-based VRB-to-PRB interleaver.

In some cases, the indication of the set of VRBs comprises one of (1) a bitmap defined with respect to the continuous set of frequency resources indicated in the first FDRA or (2) a RIV defined with respect to the continuous set of frequency resources indicated in the first FDRA. In some cases, the continuous set of frequency resources may be defined within a BWP. Assuming that the BWP is 100 resource blocks (RBs) and that the first FDRA indicates that the continuous set of frequency resources comprises RBs 50-100, the RIV encoding may be based on the 100 RBs of the BWP or the 50 RBs indicated by the first FDRA.

### Example Operations of a User Equipment

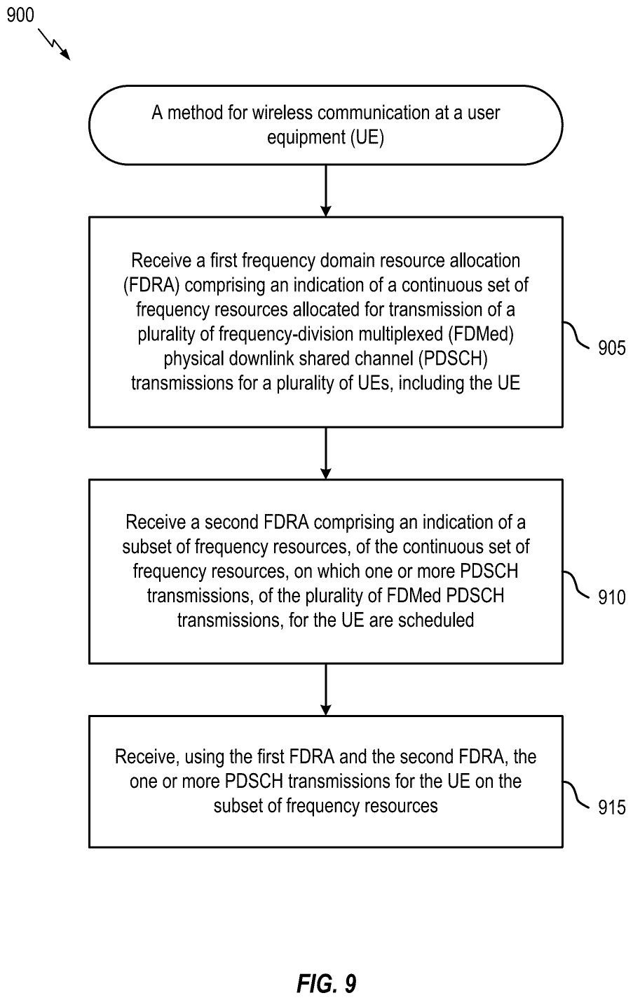

FIG. 9 shows an example of a method 900 of wireless communication at a user equipment (UE), such as a UE 104 of FIGS. 1 and 3.

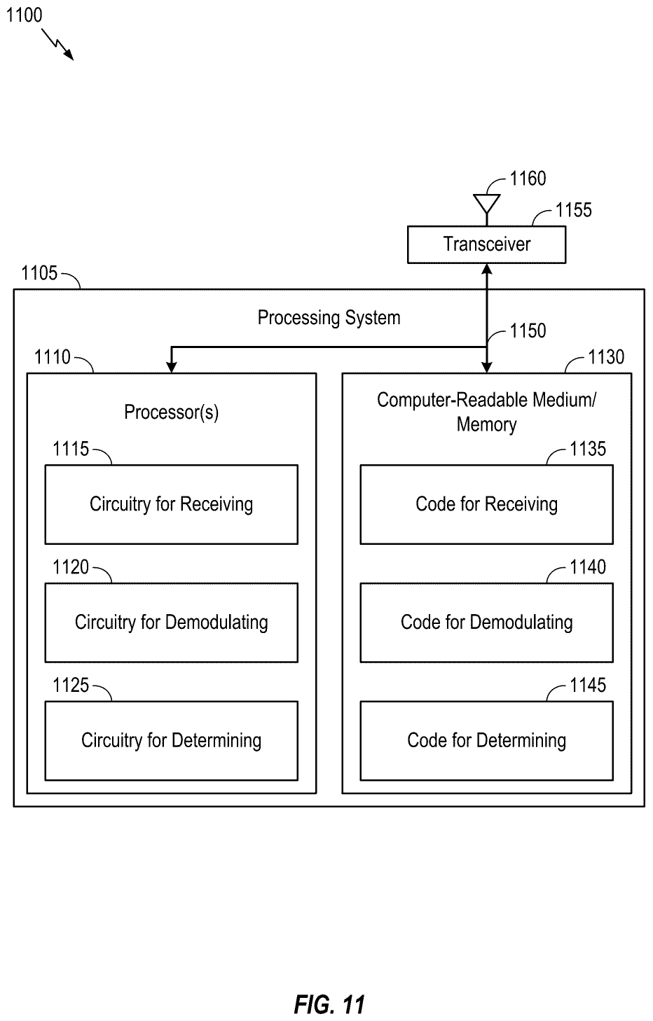

Method 900 begins at step 905 with receiving a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of UEs, including the UE. In some cases, the operations of this step refer to, or may be performed by, circuitry for receiving and/or code for receiving as described with reference to FIG. 11.

Method 900 then proceeds to step 910 with receiving a second FDRA comprising an indication of a subset of frequency resources, of the continuous set of frequency resources, on which one or more PDSCH transmissions, of the plurality of FDMed PDSCH transmissions, for the UE are scheduled. In some cases, the operations of this step refer to, or may be performed by, circuitry for receiving and/or code for receiving as described with reference to FIG. 11.

Method 900 then proceeds to step 915 with receiving, using the first FDRA and the second FDRA, the one or more PDSCH transmissions for the UE on the subset of frequency resources. In some cases, the operations of this step refer to, or may be performed by, circuitry for receiving and/or code for receiving as described with reference to FIG. 11.

In some aspects, the one or more PDSCH transmissions for the UE are rate matched to the subset of frequency resources.

In some aspects, the plurality of FDMed PDSCH transmissions for the plurality of UEs share a same wide-band precoder.

In some aspects, a set of shared demodulation reference signals (DMRSs) are scheduled for transmission across the continuous set of frequency resources; and the method further comprises: receiving one or more DMRSs of the set of shared DMRSs; and demodulating the received one or more PDSCH transmissions based on the received one or more DMRSs.

In some aspects, at least some DMRSs of the set of shared DMRSs are contiguous in a frequency domain.

In some aspects, the set of shared DMRSs are scheduled in frequency resources, of the continuous set of frequency resources, that are not scheduled for PDSCH transmissions of the plurality of FDMed PDSCH transmissions.

In some aspects, the continuous set of frequency resources comprises a plurality of interlaces of frequency resources.

In some aspects, each interlace of frequency resources of the plurality of interlaces of frequency resources comprises a plurality of interlace clusters; each interlace cluster of the plurality of interlace clusters occupies a first number of frequency resources of the continuous set of frequency resources; and each interlace cluster of the plurality of interlace clusters is separated from another interlace cluster of the plurality of interlace clusters by a second number of frequency resources of the continuous set of frequency resources.

In some aspects, the first number of frequency resources comprise one of a first number of resource elements (REs) or a first number of resource blocks (RBs), and the second number of frequency resources comprise one of a second number of REs or a second number of RBs.

In some aspects, the indication of the subset of frequency resources in the second FDRA comprises an indication of at least a first interlace of frequency resources assigned to the UE on which the one or more PDSCH transmissions for the UE are scheduled; and the subset of frequency resources on which the one or more PDSCH transmissions for the UE are scheduled comprise the plurality of interlace clusters of at least the first interlace of frequency resources.

In some aspects, the method 900 further includes receiving configuration information, from a network entity, indicating: the first number of frequency resources occupied by each interlace cluster of the plurality of interlace clusters of at least the first interlace of frequency resources, and the second number of frequency resources separating each interlace cluster of the plurality of interlace clusters of at least the first interlace of frequency resources. In some cases, the operations of this step refer to, or may be performed by, circuitry for receiving and/or code for receiving as described with reference to FIG. 11.

In some aspects, the message comprises one of a radio resource control (RRC) message, a layer 2 (L2) message, or a downlink control information (DCI) message.

In some aspects, the indication of at least the first interlace of frequency resources comprises a bitmap; the bitmap comprises a plurality of bits; and each different bit of the plurality of bits corresponds to a different interlace of frequency resources of the plurality of interlaces of frequency resources.

In some aspects, a first bit value of the different bit indicates that the different interlace corresponding to that different bit is assigned to the UE; and a second bit value of the different bit indicates that the different interlace corresponding to that different bit is not assigned to the UE.

In some aspects, the indication of the subset of frequency resources in the second FDRA comprises a resource indication value (RIV); and the RIV indicates a starting interlace and a number of contiguous interlaces that are assigned to the UE.

In some aspects, the indication of a subset of frequency resources in the second FDRA comprises an indication of a set of virtual resource blocks (VRBs) included within one or more resource block groups (RBGs) defined within the continuous set of frequency resources; the set of VRBs maps to a corresponding set of physical resource blocks (PRBs) in the continuous set of frequency resources indicated in the first FDRA based on an RBG-based VRB-to-PRB interleaver; and the subset of frequency resources comprise the set of PRBs.

In some aspects, the method 900 further includes receiving an indication of an interleaver depth of the RBG-based VRB-to-PRB interleaver. In some cases, the operations of this step refer to, or may be performed by, circuitry for receiving and/or code for receiving as described with reference to FIG. 11.

In some aspects, the indication of the interleaver depth is received in radio resource control (RRC) signaling from a network entity.

In some aspects, the method 900 further includes determining the set of PRBs to which the set of VRBs correspond based on the interleaver depth of the RBG-based VRB-to-PRB interleaver. In some cases, the operations of this step refer to, or may be performed by, circuitry for determining and/or code for determining as described with reference to FIG. 11.

In some aspects, the continuous set of frequency resources are included within a bandwidth part (BWP).

In some aspects, the RBG-based VRB-to-PRB interleaver is defined with respect to the continuous set of frequency resources indicated in the first FDRA.

In some aspects, the set of VRBs are defined with respect to the BWP.

In some aspects, the indication of the set of VRBs comprises one of: a bitmap defined with respect to the continuous set of frequency resources indicated in the first FDRA; or a resource indication value (RIV) defined with respect to the continuous set of frequency resources indicated in the first FDRA.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

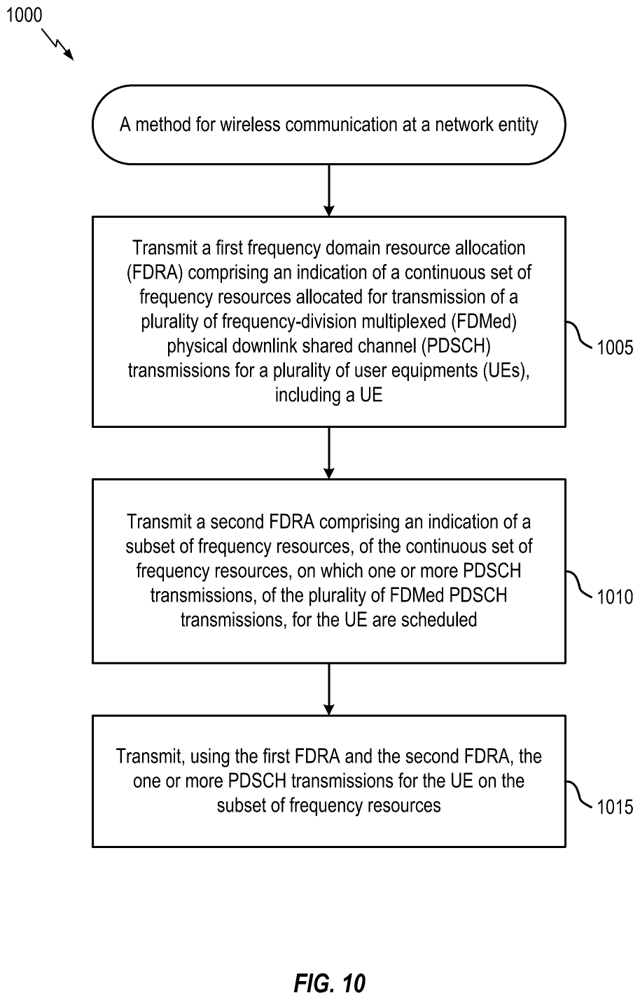

FIG. 10 shows an example of a method 1000 of wireless communication at a network entity, such as a BS 102 of FIGS. 1 and 3, or a disaggregated base station as discussed with respect to FIG. 2.

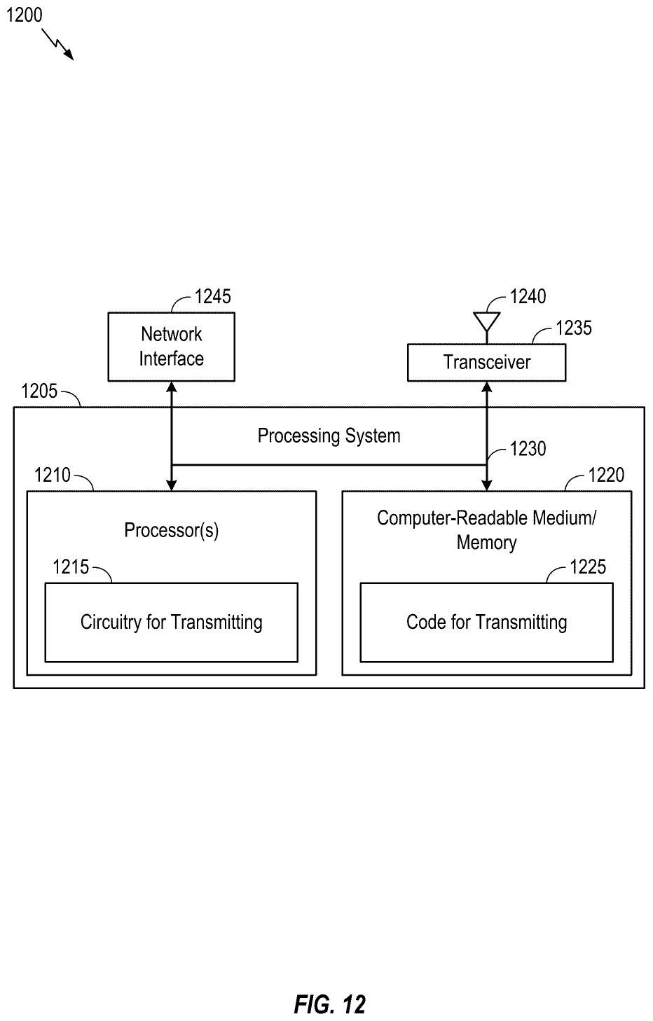

Method 1000 begins at step 1005 with transmitting a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of user equipments (UEs), including a UE. In some cases, the operations of this step refer to, or may be performed by, circuitry for transmitting and/or code for transmitting as described with reference to FIG. 12.

Method 1000 then proceeds to step 1010 with transmitting a second FDRA comprising an indication of a subset of frequency resources, of the continuous set of frequency resources, on which one or more PDSCH transmissions, of the plurality of FDMed PDSCH transmissions, for the UE are scheduled. In some cases, the operations of this step refer to, or may be performed by, circuitry for transmitting and/or code for transmitting as described with reference to FIG. 12.

Method 1000 then proceeds to step 1015 with transmitting, using the first FDRA and the second FDRA, the one or more PDSCH transmissions for the UE on the subset of frequency resources. In some cases, the operations of this step refer to, or may be performed by, circuitry for transmitting and/or code for transmitting as described with reference to FIG. 12.

In some aspects, the one or more PDSCH transmissions for the UE are rate matched to the subset of frequency resources.

In some aspects, the plurality of FDMed PDSCH transmissions for the plurality of UEs share a same wide-band precoder.

In some aspects, a set of shared demodulation reference signals (DMRSs) are scheduled for transmission across the continuous set of frequency resources.

In some aspects, at least some DMRSs of the set of shared DMRSs are contiguous in a frequency domain.

In some aspects, the set of shared DMRSs are scheduled in frequency resources, of the continuous set of frequency resources, that are not scheduled for PDSCH transmissions of the plurality of FDMed PDSCH transmissions.

In some aspects, the continuous set of frequency resources comprises a plurality of interlaces of frequency resources.

In some aspects, each interlace of frequency resources of the plurality of interlaces of frequency resources comprises a plurality of interlace clusters; each interlace cluster of the plurality of interlace clusters occupies a first number of frequency resources of the continuous set of frequency resources; and each interlace cluster of the plurality of interlace clusters is separated from another interlace cluster of the plurality of interlace clusters by a second number of frequency resources of the continuous set of frequency resources.

In some aspects, the first number of frequency resources comprise one of a first number of resource elements (REs) or a first number of resource blocks (RBs), and the second number of frequency resources comprise one of a second number of REs or a second number of RBs.

In some aspects, the indication of the subset of frequency resources in the second FDRA comprises an indication of at least a first interlace of frequency resources assigned to the UE on which the one or more PDSCH transmissions for the UE are scheduled; and the subset of frequency resources on which the one or more PDSCH transmissions for the UE are scheduled comprise the plurality of interlace clusters of at least the first interlace of frequency resources.

In some aspects, the method 1000 further includes transmitting a configuration information, to the UE, indicating: the first number of frequency resources occupied by each interlace cluster of the plurality of interlace clusters of at least the first interlace of frequency resources, and the second number of frequency resources separating each interlace cluster of the plurality of interlace clusters of at least the first interlace of frequency resources. In some cases, the operations of this step refer to, or may be performed by, circuitry for transmitting and/or code for transmitting as described with reference to FIG. 12.

In some aspects, the configuration information comprises one of a radio resource control (RRC) message, a layer 2 (L2) message, or a downlink control information (DCI) message.

In some aspects, the indication of at least the first interlace of frequency resources comprises a bitmap; the bitmap comprises a plurality of bits; and each different bit of the plurality of bits corresponds to a different interlace of frequency resources of the plurality of interlaces of frequency resources.

In some aspects, a first bit value of the different bit indicates that the different interlace corresponding to that different bit is assigned to the UE; and a second bit value of the different bit indicates that the different interlace corresponding to that different bit is not assigned to the UE.

In some aspects, the method 1000 further includes transmitting an indication of an interleaver depth of the RBG-based VRB-to-PRB interleaver. In some cases, the operations of this step refer to, or may be performed by, circuitry for transmitting and/or code for transmitting as described with reference to FIG. 12.

In some aspects, the RBG-based VRB-to-PRB interleaver is defined with respect to the continuous set of frequency resources indicated in the first FDRA.

In some aspects, the set of VRBs are defined with respect to the BWP.

In some aspects, the indication of the set of VRBs comprises one of: a bitmap defined with respect to the continuous set of frequency resources indicated in the first FDRA; or a resource indication value (RIV) defined with respect to the continuous set of frequency resources indicated in the first FDRA.

In some aspects, the continuous set of frequency resources are included within a bandwidth part (BWP).

In some aspects, the indication of the subset of frequency resources in the second FDRA comprises a resource indication value (RIV); and the RIV indicates a starting interlace and a number of contiguous interlaces that are assigned to the UE.

In some aspects, the indication of the interleaver depth is received in radio resource control (RRC) signaling from a network entity.

In some aspects, the indication of a subset of frequency resources in the second FDRA comprises an indication of a set of virtual resource blocks (VRBs) included within one or more resource block groups (RBGs) defined within the continuous set of frequency resources; the set of VRBs maps to a corresponding set of physical resource blocks (PRBs) in the continuous set of frequency resources indicated in the first FDRA based on an RBG-based VRB-to-PRB interleaver; and the subset of frequency resources comprise the set of PRBs.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Device(s)

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to the transceiver 1155 (e.g., a transmitter and/or a receiver). The transceiver 1155 is configured to transmit and receive signals for the communications device 1100 via the antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 900 described with respect to FIG. 9, or any aspect related to it. Note that reference to a processor performing a function of communications device 1100 may include one or more processors 1110 performing that function of communications device 1100.

In the depicted example, computer-readable medium/memory 1130 stores code (e.g., executable instructions), such as code for receiving 1135, code for demodulating 1140, and code for determining 1145. Processing of the code for receiving 1135, code for demodulating 1140, and code for determining 1145 may cause the communications device 1100 to perform the method 900 described with respect to FIG. 9, or any aspect related to it.

The one or more processors 1110 include circuitry configured to implement (e.g., execute) the code stored in the computer-readable medium/memory 1130, including circuitry such as circuitry for receiving 1115, circuitry for demodulating 1120, and circuitry for determining 1125. Processing with circuitry for receiving 1115, circuitry for demodulating 1120, and circuitry for determining 1125 may cause the communications device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3 and/or the transceiver 1155 and the antenna 1160 of the communications device 1100 in FIG. 11. Means for receiving or obtaining may include transceivers 354 and/or antenna(s) 352 of the UE 104 illustrated in FIG. 3 and/or the transceiver 1155 and the antenna 1160 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1235 (e.g., a transmitter and/or a receiver) and/or a network interface 1245. The transceiver 1235 is configured to transmit and receive signals for the communications device 1200 via the antenna 1240, such as the various signals as described herein. The network interface 1245 is configured to obtain and send signals for the communications device 1200 via communication link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1220 via a bus 1230. In certain aspects, the computer-readable medium/memory 1220 is configured to store instructions (e.g., computer-executable code) that when executed by the one or more processors 1210, cause the one or more processors 1210 to perform the method 1000 described with respect to FIG. 10, or any aspect related to it. Note that reference to a processor of communications device 1200 performing a function may include one or more processors 1210 of communications device 1200 performing that function.

In the depicted example, the computer-readable medium/memory 1220 stores code (e.g., executable instructions), such as code for transmitting 1225. Processing of the code for transmitting 1225 may cause the communications device 1200 to perform the method 1000 described with respect to FIG. 10, or any aspect related to it.

The one or more processors 1210 include circuitry configured to implement (e.g., execute) the code stored in the computer-readable medium/memory 1220, including circuitry such as circuitry for transmitting 1215. Processing with circuitry for transmitting 1215 may cause the communications device 1200 to perform the method 1000 described with respect to FIG. 10, or any aspect related to it.

Various components of the communications device 1200 may provide means for performing the method 1000 described with respect to FIG. 10, or any aspect related to it. Means for transmitting, sending or outputting for transmission may include transceivers 332 and/or antenna(s) 334 of the BS 102 illustrated in FIG. 3 and/or the transceiver 1235 and the antenna 1240 of the communications device 1200 in FIG. 12. Means for receiving or obtaining may include transceivers 332 and/or antenna(s) 334 of the BS 102 illustrated in FIG. 3 and/or the transceiver 1235 and the antenna 1240 of the communications device 1200 in FIG. 12.

### Example Clauses

Implementation examples are described in the following numbered clauses:

Clause 1: A method for wireless communication at a user equipment (UE), comprising: receiving a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of UEs, including the UE; receiving a second FDRA comprising an indication of a subset of frequency resources, of the continuous set of frequency resources, on which one or more PDSCH transmissions, of the plurality of FDMed PDSCH transmissions, for the UE are scheduled; and receiving, using the first FDRA and the second FDRA, the one or more PDSCH transmissions for the UE on the subset of frequency resources.

Clause 2: The method of Clause 1, wherein the one or more PDSCH transmissions for the UE are rate matched to the subset of frequency resources.

Clause 3: The method of any one of Clauses 1-2, wherein the plurality of FDMed PDSCH transmissions for the plurality of UEs share a same wide-band precoder.

Clause 4: The method of any one of Clauses 1-3, wherein: a set of shared demodulation reference signals (DMRSs) are scheduled for transmission across the continuous set of frequency resources; and the method further comprises: receiving one or more DMRSs of the set of shared DMRSs; and demodulating the received one or more PDSCH transmissions based on the received one or more DMRSs.

Clause 5: The method of Clause 4, wherein at least some DMRSs of the set of shared DMRSs are contiguous in a frequency domain.

Clause 6: The method of Clause 4, wherein the set of shared DMRSs are scheduled in frequency resources, of the continuous set of frequency resources, that are not scheduled for PDSCH transmissions of the plurality of FDMed PDSCH transmissions.

Clause 7: The method of any one of Clauses 1-6, wherein the continuous set of frequency resources comprises a plurality of interlaces of frequency resources.

Clause 8: The method of Clause 7, wherein: each interlace of frequency resources of the plurality of interlaces of frequency resources comprises a plurality of interlace clusters; each interlace cluster of the plurality of interlace clusters occupies a first number of frequency resources of the continuous set of frequency resources; and each interlace cluster of the plurality of interlace clusters is separated from another interlace cluster of the plurality of interlace clusters by a second number of frequency resources of the continuous set of frequency resources.

Clause 9: The method of Clause 8, wherein: the first number of frequency resources comprise one of a first number of resource elements (REs) or a first number of resource blocks (RBs), and the second number of frequency resources comprise one of a second number of REs or a second number of RBs.

Clause 10: The method of Clause 8, wherein: the indication of the subset of frequency resources in the second FDRA comprises an indication of at least a first interlace of frequency resources assigned to the UE on which the one or more PDSCH transmissions for the UE are scheduled; and the subset of frequency resources on which the one or more PDSCH transmissions for the UE are scheduled comprise the plurality of interlace clusters of at least the first interlace of frequency resources.

Clause 11: The method of Clause 10, further comprising receiving configuration information, from a network entity, indicating: the first number of frequency resources occupied by each interlace cluster of the plurality of interlace clusters of at least the first interlace of frequency resources, and the second number of frequency resources separating each interlace cluster of the plurality of interlace clusters of at least the first interlace of frequency resources.

Clause 12: The method of Clause 11, wherein the message comprises one of a radio resource control (RRC) message, a layer 2 (L2) message, or a downlink control information (DCI) message.

Clause 13: The method of Clause 10, wherein: the indication of at least the first interlace of frequency resources comprises a bitmap; the bitmap comprises a plurality of bits; and each different bit of the plurality of bits corresponds to a different interlace of frequency resources of the plurality of interlaces of frequency resources.

Clause 14: The method of Clause 13, wherein: a first bit value of the different bit indicates that the different interlace corresponding to that different bit is assigned to the UE; and a second bit value of the different bit indicates that the different interlace corresponding to that different bit is not assigned to the UE.

Clause 15: The method of Clause 10, wherein: the indication of the subset of frequency resources in the second FDRA comprises a resource indication value (RIV); and the RIV indicates a starting interlace and a number of contiguous interlaces that are assigned to the UE.

Clause 16: The method of any one of Clauses 1-15, wherein: the indication of a subset of frequency resources in the second FDRA comprises an indication of a set of virtual resource blocks (VRBs) included within one or more resource block groups (RBGs) defined within the continuous set of frequency resources; the set of VRBs maps to a corresponding set of physical resource blocks (PRBs) in the continuous set of frequency resources indicated in the first FDRA based on an RBG-based VRB-to-PRB interleaver; and the subset of frequency resources comprise the set of PRBs.

Clause 17: The method of Clause 16, further comprising receiving an indication of an interleaver depth of the RBG-based VRB-to-PRB interleaver.

Clause 18: The method of Clause 17, wherein the indication of the interleaver depth is received in radio resource control (RRC) signaling from a network entity.

Clause 19: The method of Clause 17, further comprising determining the set of PRBs to which the set of VRBs correspond based on the interleaver depth of the RBG-based VRB-to-PRB interleaver.

Clause 20: The method of Clause 16, wherein the continuous set of frequency resources are included within a bandwidth part (BWP).

Clause 21: The method of Clause 20, wherein the RBG-based VRB-to-PRB interleaver is defined with respect to the continuous set of frequency resources indicated in the first FDRA.

Clause 22: The method of Clause 20, wherein the set of VRBs are defined with respect to the BWP.

Clause 23: The method of Clause 20, wherein the indication of the set of VRBs comprises one of: a bitmap defined with respect to the continuous set of frequency resources indicated in the first FDRA; or a resource indication value (RIV) defined with respect to the continuous set of frequency resources indicated in the first FDRA.

Clause 24: A method for wireless communication at a network entity, comprising: transmitting a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of user equipments (UEs), including a UE; transmitting a second FDRA comprising an indication of a subset of frequency resources, of the continuous set of frequency resources, on which one or more PDSCH transmissions, of the plurality of FDMed PDSCH transmissions, for the UE are scheduled; and transmitting, using the first FDRA and the second FDRA, the one or more PDSCH transmissions for the UE on the subset of frequency resources.

Clause 25: The method of Clause 24, wherein the one or more PDSCH transmissions for the UE are rate matched to the subset of frequency resources.

Clause 26: The method of any one of Clauses 24-25, wherein the plurality of FDMed PDSCH transmissions for the plurality of UEs share a same wide-band precoder.

Clause 27: The method of any one of Clauses 24-26, wherein: a set of shared demodulation reference signals (DMRSs) are scheduled for transmission across the continuous set of frequency resources.

Clause 28: The method of Clause 27, wherein at least some DMRSs of the set of shared DMRSs are contiguous in a frequency domain.

Clause 29: The method of Clause 27, wherein the set of shared DMRSs are scheduled in frequency resources, of the continuous set of frequency resources, that are not scheduled for PDSCH transmissions of the plurality of FDMed PDSCH transmissions.

Clause 30: The method of any one of Clauses 24-29, wherein the continuous set of frequency resources comprises a plurality of interlaces of frequency resources.

Clause 31: The method of Clause 30, wherein: each interlace of frequency resources of the plurality of interlaces of frequency resources comprises a plurality of interlace clusters; each interlace cluster of the plurality of interlace clusters occupies a first number of frequency resources of the continuous set of frequency resources; and each interlace cluster of the plurality of interlace clusters is separated from another interlace cluster of the plurality of interlace clusters by a second number of frequency resources of the continuous set of frequency resources.

Clause 32: The method of Clause 31, wherein: the first number of frequency resources comprise one of a first number of resource elements (REs) or a first number of resource blocks (RBs), and the second number of frequency resources comprise one of a second number of REs or a second number of RBs.

Clause 33: The method of Clause 31, wherein: the indication of the subset of frequency resources in the second FDRA comprises an indication of at least a first interlace of frequency resources assigned to the UE on which the one or more PDSCH transmissions for the UE are scheduled; and the subset of frequency resources on which the one or more PDSCH transmissions for the UE are scheduled comprise the plurality of interlace clusters of at least the first interlace of frequency resources.

Clause 34: The method of Clause 33, further comprising transmitting a configuration information, to the UE, indicating: the first number of frequency resources occupied by each interlace cluster of the plurality of interlace clusters of at least the first interlace of frequency resources, and the second number of frequency resources separating each interlace cluster of the plurality of interlace clusters of at least the first interlace of frequency resources.

Clause 35: The method of Clause 34, wherein the configuration information comprises one of a radio resource control (RRC) message, a layer 2 (L2) message, or a downlink control information (DCI) message.

Clause 36: The method of Clause 33, wherein: the indication of at least the first interlace of frequency resources comprises a bitmap; the bitmap comprises a plurality of bits; and each different bit of the plurality of bits corresponds to a different interlace of frequency resources of the plurality of interlaces of frequency resources.

Clause 37: The method of Clause 36, wherein: a first bit value of the different bit indicates that the different interlace corresponding to that different bit is assigned to the UE; and a second bit value of the different bit indicates that the different interlace corresponding to that different bit is not assigned to the UE.

Clause 38: The method of Clause 33, wherein: the indication of the subset of frequency resources in the second FDRA comprises a resource indication value (RIV); and the RIV indicates a starting interlace and a number of contiguous interlaces that are assigned to the UE.

Clause 39: The method of any one of Clauses 24-38, wherein: the indication of a subset of frequency resources in the second FDRA comprises an indication of a set of virtual resource blocks (VRBs) included within one or more resource block groups (RBGs) defined within the continuous set of frequency resources; the set of VRBs maps to a corresponding set of physical resource blocks (PRBs) in the continuous set of frequency resources indicated in the first FDRA based on an RBG-based VRB-to-PRB interleaver; and the subset of frequency resources comprise the set of PRBs.

Clause 40: The method of Clause 37, further comprising transmitting an indication of an interleaver depth of the RBG-based VRB-to-PRB interleaver.

Clause 41: The method of Clause 38, wherein the indication of the interleaver depth is received in radio resource control (RRC) signaling from a network entity.

Clause 42: The method of Clause 37, wherein the continuous set of frequency resources are included within a bandwidth part (BWP).

Clause 43: The method of Clause 40, wherein the RBG-based VRB-to-PRB interleaver is defined with respect to the continuous set of frequency resources indicated in the first FDRA.

Clause 44: The method of Clause 40, wherein the set of VRBs are defined with respect to the BWP.

Clause 45: The method of Clause 40, wherein the indication of the set of VRBs comprises one of: a bitmap defined with respect to the continuous set of frequency resources indicated in the first FDRA; or a resource indication value (RIV) defined with respect to the continuous set of frequency resources indicated in the first FDRA.

Clause 46: An apparatus, comprising: at least one memory comprising executable instructions; and at least one processor configured to execute the executable instructions and cause the apparatus to perform a method in accordance with any combination of Clauses 1-45.

Clause 47: An apparatus, comprising means for performing a method in accordance with any combination of Clauses 1-45.

Clause 48: A non-transitory computer-readable medium comprising executable instructions that, when executed by at least one processor of an apparatus, cause the apparatus to perform a method in accordance with any combination of Clauses 1-45.

Clause 49: A computer program product embodied on a computer-readable storage medium comprising code for performing a method in accordance with any combination of Clauses 1-45.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) for wireless communication, comprising:
one or more processors individually or collectively configured to execute instructions stored on one or more memories and to cause the UE to:
receive a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of UEs, including the UE;
receive a second FDRA comprising an indication of a subset of frequency resources, of the continuous set of frequency resources, on which one or more PDSCH transmissions, of the plurality of FDMed PDSCH transmissions, for the UE are scheduled; and
receive, using the first FDRA and the second FDRA, the one or more PDSCH transmissions for the UE on the subset of frequency resources.

2. The UE of claim 1, wherein the one or more PDSCH transmissions for the UE are rate matched to the subset of frequency resources.

3. The UE of claim 1, wherein the plurality of FDMed PDSCH transmissions for the plurality of UEs share a same wide-band precoder.

4. The UE of claim 1, wherein:
a set of shared demodulation reference signals (DMRSs) are scheduled for transmission across the continuous set of frequency resources;
the one or more processors are further configured to cause the UE to:
receive one or more DMRSs of the set of shared DMRSs; and
demodulate the received one or more PDSCH transmissions based on the received one or more DMRSs;
at least some DMRSs of the set of shared DMRSs are contiguous in a frequency domain; and
the set of shared DMRSs are scheduled in frequency resources, of the continuous set of frequency resources, that are not scheduled for PDSCH transmissions of the plurality of FDMed PDSCH transmissions.

5. The UE of claim 1, wherein:
the continuous set of frequency resources comprises a plurality of interlaces of frequency resources;
each interlace of frequency resources of the plurality of interlaces of frequency resources comprises a plurality of interlace clusters;
each interlace cluster of the plurality of interlace clusters occupies a first number of frequency resources of the continuous set of frequency resources; and
each interlace cluster of the plurality of interlace clusters is separated from another interlace cluster of the plurality of interlace clusters by a second number of frequency resources of the continuous set of frequency resources.

6. The UE of claim 5, wherein:
the indication of the subset of frequency resources in the second FDRA comprises an indication of at least a first interlace of frequency resources assigned to the UE on which the one or more PDSCH transmissions for the UE are scheduled; and
the subset of frequency resources on which the one or more PDSCH transmissions for the UE are scheduled comprise the plurality of interlace clusters of at least the first interlace of frequency resources.

7. The UE of claim 6, wherein:
the one or more processors are further configured to cause the UE to receive configuration information, from a network entity, indicating:
the first number of frequency resources occupied by each interlace cluster of the plurality of interlace clusters of at least the first interlace of frequency resources; and
the second number of frequency resources separating each interlace cluster of the plurality of interlace clusters of at least the first interlace of frequency resources; and
the configuration information comprises one of a radio resource control (RRC) message, a layer 2 (L2) message, or a downlink control information (DCI) message.

8. The UE of claim 6, wherein:
the indication of at least the first interlace of frequency resources comprises a bitmap;
the bitmap comprises a plurality of bits;
each different bit of the plurality of bits corresponds to a different interlace of frequency resources of the plurality of interlaces of frequency resources;
a first bit value of the different bit indicates that the different interlace corresponding to that different bit is assigned to the UE; and
a second bit value of the different bit indicates that the different interlace corresponding to that different bit is not assigned to the UE.

9. The UE of claim 6, wherein:
the indication of the subset of frequency resources in the second FDRA comprises a resource indication value (RIV); and
the RIV indicates a starting interlace and a number of contiguous interlaces that are assigned to the UE.

10. The UE of claim 1, wherein:
the indication of a subset of frequency resources in the second FDRA comprises an indication of a set of virtual resource blocks (VRBs) included within one or more resource block groups (RBGs) defined within the continuous set of frequency resources;
the set of VRBs maps to a corresponding set of physical resource blocks (PRBs) in the continuous set of frequency resources indicated in the first FDRA based on an RBG-based VRB-to-PRB interleaver; and
the subset of frequency resources comprise the set of PRBs;
the one or more processors are further configured to cause the UE to receive an indication of an interleaver depth of the RBG-based VRB-to-PRB interleaver;
the indication of the interleaver depth is received in radio resource control (RRC) signaling from a network entity; and
the one or more processors are further configured to cause the UE to determine the set of PRBs to which the set of VRBs correspond based on the interleaver depth of the RBG-based VRB-to-PRB interleaver.

11. The UE of claim 10, wherein the continuous set of frequency resources are included within a bandwidth part (BWP).

12. The UE of claim 11, wherein, one of:
the RBG-based VRB-to-PRB interleaver is defined with respect to the continuous set of frequency resources indicated in the first FDRA; or
the set of VRBs are defined with respect to the BWP.

13. The UE of claim 11, wherein the indication of the set of VRBs comprises one of:
a bitmap defined with respect to the continuous set of frequency resources indicated in the first FDRA; or
a resource indication value (RIV) defined with respect to the continuous set of frequency resources indicated in the first FDRA.

14. A network entity for wireless communication, comprising:
one or more processors individually or collectively configured to execute instructions stored on one or more memories and to cause the network entity to:
transmit a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of user equipments (UEs), including a UE;
transmit a second FDRA comprising an indication of a subset of frequency resources, of the continuous set of frequency resources, on which one or more PDSCH transmissions, of the plurality of FDMed PDSCH transmissions, for the UE are scheduled; and
transmit, using the first FDRA and the second FDRA, the one or more PDSCH transmissions for the UE on the subset of frequency resources.

15. The network entity of claim 14, wherein the one or more PDSCH transmissions for the UE are rate matched to the subset of frequency resources.

16. The network entity of claim 14, wherein the plurality of FDMed PDSCH transmissions for the plurality of UEs share a same wide-band precoder.

17. The network entity of claim 14, wherein:
a set of shared demodulation reference signals (DMRSs) are scheduled for transmission across the continuous set of frequency resources;
at least some DMRSs of the set of shared DMRSs are contiguous in a frequency domain; and
the set of shared DMRSs are scheduled in frequency resources, of the continuous set of frequency resources, that are not scheduled for PDSCH transmissions of the plurality of FDMed PDSCH transmissions.

18. The network entity of claim 14, wherein:
the continuous set of frequency resources comprises a plurality of interlaces of frequency resources;
each interlace of frequency resources of the plurality of interlaces of frequency resources comprises a plurality of interlace clusters;
each interlace cluster of the plurality of interlace clusters occupies a first number of frequency resources of the continuous set of frequency resources; and
each interlace cluster of the plurality of interlace clusters is separated from another interlace cluster of the plurality of interlace clusters by a second number of frequency resources of the continuous set of frequency resources.

19. The network entity of claim 18, wherein:
the indication of the subset of frequency resources in the second FDRA comprises an indication of at least a first interlace of frequency resources assigned to the UE on which the one or more PDSCH transmissions for the UE are scheduled; and
the subset of frequency resources on which the one or more PDSCH transmissions for the UE are scheduled comprise the plurality of interlace clusters of at least the first interlace of frequency resources.

20. The network entity of claim 19, wherein:
the one or more processors are further configured to cause the network entity to transmit configuration information, to the UE, indicating:
the first number of frequency resources occupied by each interlace cluster of the plurality of interlace clusters of at least the first interlace of frequency resources; and
the second number of frequency resources separating each interlace cluster of the plurality of interlace clusters of at least the first interlace of frequency resources; and
the configuration information comprises one of a radio resource control (RRC) message, a layer 2 (L2) message, or a downlink control information (DCI) message.

21. The network entity of claim 19, wherein:
the indication of at least the first interlace of frequency resources comprises a bitmap;
the bitmap comprises a plurality of bits;
each different bit of the plurality of bits corresponds to a different interlace of frequency resources of the plurality of interlaces of frequency resources;
a first bit value of the different bit indicates that the different interlace corresponding to that different bit is assigned to the UE; and
a second bit value of the different bit indicates that the different interlace corresponding to that different bit is not assigned to the UE.

22. The network entity of claim 19, wherein:
the indication of the subset of frequency resources in the second FDRA comprises a resource indication value (RIV); and
the RIV indicates a starting interlace and a number of contiguous interlaces that are assigned to the UE.

23. The network entity of claim 14, wherein:
the indication of a subset of frequency resources in the second FDRA comprises an indication of a set of virtual resource blocks (VRBs) included within one or more resource block groups (RBGs) defined within the continuous set of frequency resources;
the set of VRBs maps to a corresponding set of physical resource blocks (PRBs) in the continuous set of frequency resources indicated in the first FDRA based on an RBG-based VRB-to-PRB interleaver; and
the subset of frequency resources comprise the set of PRBs.

24. The network entity of claim 23, wherein:
the one or more processors are further configured to cause the network entity to transmit an indication of an interleaver depth of the RBG-based VRB-to-PRB interleaver; and
the indication of the interleaver depth is received in radio resource control (RRC) signaling from a network entity.

25. The network entity of claim 23, wherein the continuous set of frequency resources are included within a bandwidth part (BWP).

26. The network entity of claim 25, wherein the RBG-based VRB-to-PRB interleaver is defined with respect to the continuous set of frequency resources indicated in the first FDRA.

27. The network entity of claim 25, wherein the set of VRBs are defined with respect to the BWP.

28. The network entity of claim 25, wherein the indication of the set of VRBs comprises one of:
a bitmap defined with respect to the continuous set of frequency resources indicated in the first FDRA; or
a resource indication value (RIV) defined with respect to the continuous set of frequency resources indicated in the first FDRA.

29. A method for wireless communication at a user equipment (UE), comprising:
receiving a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of UEs, including the UE;
receiving a second FDRA comprising an indication of a subset of frequency resources, of the continuous set of frequency resources, on which one or more PDSCH transmissions, of the plurality of FDMed PDSCH transmissions, for the UE are scheduled; and
receiving, using the first FDRA and the second FDRA, the one or more PDSCH transmissions for the UE on the subset of frequency resources.

30. A method for wireless communication at a network entity, comprising:
transmitting a first frequency domain resource allocation (FDRA) comprising an indication of a continuous set of frequency resources allocated for transmission of a plurality of frequency-division multiplexed (FDMed) physical downlink shared channel (PDSCH) transmissions for a plurality of user equipments (UEs), including a UE;
transmitting a second FDRA comprising an indication of a subset of frequency resources, of the continuous set of frequency resources, on which one or more PDSCH transmissions, of the plurality of FDMed PDSCH transmissions, for the UE are scheduled; and
transmitting, using the first FDRA and the second FDRA, the one or more PDSCH transmissions for the UE on the subset of frequency resources.
